(19) United States
(12) Patent Application Publication
(10) Pub. No.: US 2008/0136667 A1
(43) Pub. Date: Jun. 12, 2008

(54) Network for automated meter reading

(76) Inventors: Raj Vaswani, Portola Valley, CA (US); George Flammer, Cupterino, CA (US); Donn R. Dresselhuys, Shorewood, WI (US)

Correspondence Address: BUCHANAN, INGERSOLL & ROONEY PC, POST OFFICE BOX 1404, ALEXANDRIA, VA, 22313-1404, US

(21) Appl. No.: 12/003,709

(22) Filed: Dec. 31, 2007

Related U.S. Application Data
(63) Continuation-in-part of application No. 11/894,333, filed on Aug. 21, 2007.
Application No. 11/894,333 is a division of application No. 10/672,781, filed on Sep. 26, 2003, now Pat. No. 7,277,027.
Application No. 10/672,781 is a continuation of application No. 10/319,856, filed on Dec. 13, 2002, now abandoned.
Application No. 10/319,856 is a continuation of application No. 09/242,792, filed on Feb. 23, 1999, now Pat. No. 6,538,577.

(51) Int. Cl. G08B 23/00

(52) U.S. Cl. 340/870.02

(57) ABSTRACT

A networked automatic meter reading system includes a plurality of meters that measure commodity usage and monitor quality parameters for transmission to a utility over a two-way local area network (LAN) to a remotely located gateway node. The gateway node transmits this data to the utility over a commercially available fixed wide area network (WAN). The meter can also provide direct communication to the utility over a commercially available network interface that plugs into the meter, bypassing the local area network communication link and gateway node. The meter also provides an interface to an in-premises network that communicates with consumer devices in a household or other facility. The gateway performs routing analysis of packets to determine preferred routing paths, and disseminates this information to the meters.

### CROSS-REFERENCE TO RELATED APPLICATIONS

This document is a continuation-in-part of U.S. application Ser. No. 11/894,333, filed Aug. 21, 2007, which is a divisional of U.S. application Ser. No. 10/672,781, filed Sep. 26, 2003, now U.S. Pat. No. 7,277,027, which is a continuation of U.S. application Ser. No. 10/319,856, filed Dec. 13, 2002, now abandoned, which is a continuation of U.S. application Ser. No. 09/242,792, filed Feb. 23, 1999, now U.S. Pat. No. 6,538,577, the entire contents of each of which are hereby incorporated by reference.

### BACKGROUND OF THE INVENTION

The present invention relates to a system for the automated measurement and management of usage of a commodity. More particularly, the invention relates to an electronic meter for measuring consumption of a commodity such as electricity, and a network for communicating that usage data and other related information to a utility over a two-way wireless local area network (LAN) to a remotely located gateway node that transmits the data over a two-way fixed common carrier wide area network (WAN), or communicating that data directly to the utility, over a commercially available two-way data communication network.

Commodity usage is conventionally determined by utility companies using meters that monitor subscriber consumption. The utility service provider typically determines the subscriber's consumption by sending a service person to each meter location to manually record the information displayed on the meter dial. The manual reading is then entered into a computer which processes the information and outputs a billing statement for the subscriber. Sometimes it may be difficult for the service person to access the meter for reading, inspection and maintenance. When access to a meter is not possible, billings are made on the basis of estimated readings. These estimated billings often lead to customer complaints.

Currently available meters, such as electric watt-hour meters, work well for their intended purpose, but they must be manually read. This makes it difficult to cost effectively measure commodity usage for each user to promote fair billing and encourage conservation. Manual reading of meters is highly labor intensive, inefficient and expensive. Therefore, there has been a strong interest on the part of utility companies to take advantage of modern technology to reduce operating costs and increase efficiency by eliminating the necessity for manual readings.

Many attempts have been made in recent years to develop an automatic meter reading system for meters which avoid the high costs of manual meter reading. However, most of these prior art systems have achieved little success. For automatic or remote meter reading, a transducer unit must be used with the meters to detect the output of such meters and transmit that information back to the utility.

Various types of devices have been attached to utility meters in an effort to simplify meter reading. These devices were developed to transfer commodity usage data over a communication link to a centrally located service center or utility. These communication links included telephone lines, power lines, or a radio frequency (RF) link.

The use of existing telephone lines and power lines to communicate commodity usage data to a utility have encountered significant technical difficulties. In a telephone line system, the meter data may interfere with the subscriber's normal phone line operation, and requires cooperation between the telephone company and the utility company for shared use of the telephone lines. A telephone line communication link also requires a hard wire connection between the meter and the main telephone line, increasing installation costs. The use of a power line carrier (PLC) communication link over existing power lines would again require a hard wire connection between the meter and the main power line. Another disadvantage of the PLC system is the possibility of losing data from interference on the power line.

Meters have been developed which can be read remotely. Such meters are configured as transducers and include a radio transmitter for transmitting data to the utility. These prior art systems required the meter to be polled on a regular basis by a data interrogator. The data interrogator may be mounted to a mobile unit traveling around the neighborhood, incorporated within a portable hand-held unit carried by a service person, or mounted at a centrally located site. When the meter is interrogated by an RF signal from the data interrogator, the meter responds by transmitting a signal encoded with the meter reading and any other information requested. The meter does not initiate the communication.

However, such prior art systems have disadvantages. The first disadvantage is that the device mounted to the meter generally has a small transceiver with a very low power output and thus a very short range. This requires that the interrogation unit be in close proximity to the meters. Another disadvantage is that the device attached to the meter must be polled on a regular basis by the data interrogator. The device attached to the meter is not able to initiate a communication. The mobile and hand-held data interrogators are of limited value since it is still necessary for utility service personnel to travel around neighborhoods and businesses to remotely read the meters. It only avoids the necessity of entering a residence or other building to read the meters. The systems utilizing a data interrogator at fixed locations still have the disadvantages of low power output from the devices attached to the meters, and requiring polling by the data interrogator to initiate communication.

### SUMMARY OF THE INVENTION

Disclosed herein is a fully electronic meter for collecting, processing and transmitting commodity utilization and power quality data to a utility service provider. The electronic meter is of a modular design allowing for the removal and interchangeability of circuit boards and modules within the meter. All of the circuit boards and modules plug into a common backplane or busing system.

The meter is able to communicate commodity utilization data and power quality information to a utility over a local area network (LAN) or a wide area network (WAN). In one embodiment, a radio frequency (RF) transceiver located within the meter creates a LAN link between the meter and a gateway node located remotely from the meter. This LAN can utilize a 900 MHz spread spectrum communication technique for transmitting commodity utilization data and power quality information from the meter to the gateway node, and for receiving interrogation signals from the gateway node.

In another embodiment, the meter is also able to communicate directly with the utility through the variety of commercially available communication network interface modules that plug into the meter's backplane or bus system. For example, these modules might include a narrowband personal communication services (PCS) module or a power line carrier (PLC) module. For these modules, a gateway node is not necessary to complete the communication link between the meter and the utility. One class of PLC modules has a built-in interface for the CEBus architecture that transmits commands and data suitable for devices in households and offices. Electric meters with PLC modules having CEBus interface can also communicate with consumer devices or with networks using the CEBus architecture. As a result, the meter itself can operation as a gateway between the network for communicating with the utility and an in-premises network that provides communication with consumer devices located in the households and offices.

The gateway node is located remotely from the meter to complete the local area network. The gateway node is made up of four major components. These components include a wide area network interface module, an initialization microcontroller, a spread spectrum processor and a RF transceiver. The gateway node is responsible for providing interrogation signals to the meter and for receiving commodity utilization data from the interface management unit for the local area network. The gateway node can also provide the link to the utility service provider over a commercially available fixed two-way common carrier wide area network.

The RF transceiver of the gateway node transmits interrogation signals from the utility or preprogrammed signals for scheduled readings to the electric meter, and receives commodity utilization data in return from the meter for transmission to the utility over the wide area network. The spread spectrum processor is coupled to the RF transceiver and enables the gateway node to transmit and receive data utilizing the spread spectrum communication technique. The WAN interface module is coupled to the spread spectrum processor and transmits data to and from the utility service provider over any commercially available wide area network that is desired. A different WAN interface module can be used for each different commercially available wide area network desired. The initialization microcontroller is interposed between the interface module and the spread spectrum processor for controlling operation of the spread spectrum processor and for controlling communication within the gateway node.

Meter reading, meter information management and network communications are all controlled by two-way system software that is preprogrammed into the meter's memory during manufacture and installation. The software enables an operator to program utility identification numbers, meter settings and readings, units of measure and alarm set points.

### BRIEF DESCRIPTION OF THE SEVERAL VIEWS OF THE DRAWINGS

FIG. 1 is a perspective view of an electronic electric meter in accordance with the present invention;

FIG. 2 is a cross-sectional view of the internal structure of the electric meter shown in FIG. 1;

FIG. 3 is a block diagram of the electric meter circuitry;

FIG. 4 is a front elevational view of a gateway node;

FIG. 5 is a schematic view of the electric meter interfacing with a remote gateway node and a utility service provider, creating a networked automatic meter reading data communication system;

FIG. 6 is a flow diagram of the automatic meter reading data communication system shown in FIG. 5;

FIG. 7 is a block diagram of the gateway node circuitry;

FIG. 8 is a functional block diagram of the automatic meter reading data communication system of FIGS. 5 and 6;

FIG. 9A is a flow diagram of the WAN handler portion of the data communication system of FIG. 8;

FIG. 9B is a flow diagram of the message dispatcher portion of the data communication system of FIG. 8;

FIG. 9C is a flow diagram of the RF handler portion of the data communication system of FIG. 8;

FIG. 9D is a flow diagram of the scheduler portion of the data communication system of FIG. 8; and

FIG. 9E is a flow diagram of the data stores portion of the data communication system of FIG. 8.

### DETAILED DESCRIPTION OF THE INVENTION

To facilitate an understanding of the concepts that constitute the invention disclosed herein, implementations of the invention are described in the context of measuring usage and other characteristics of electricity delivered to a premises. It will be appreciated that the described implementations are exemplary, and that the invention is applicable to the measurement and monitoring of other commodities provided by utilities, such as natural gas, water, etc.

### Electronic Electric Meter

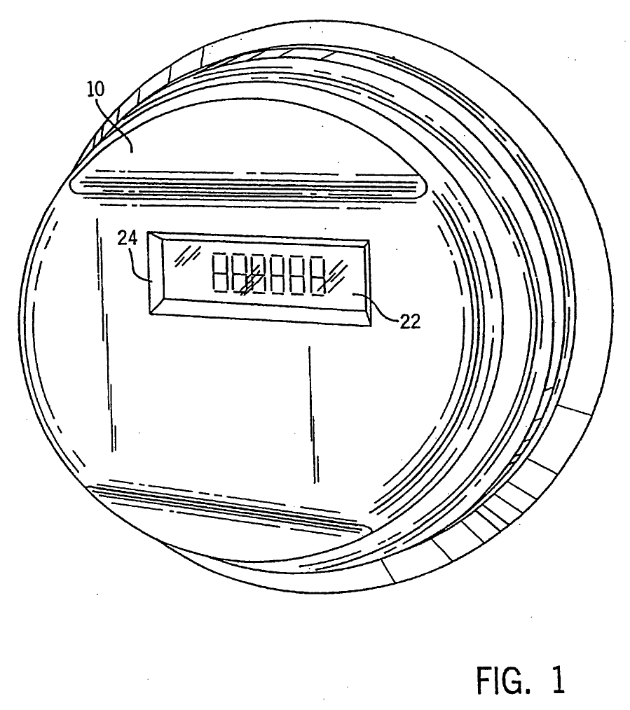

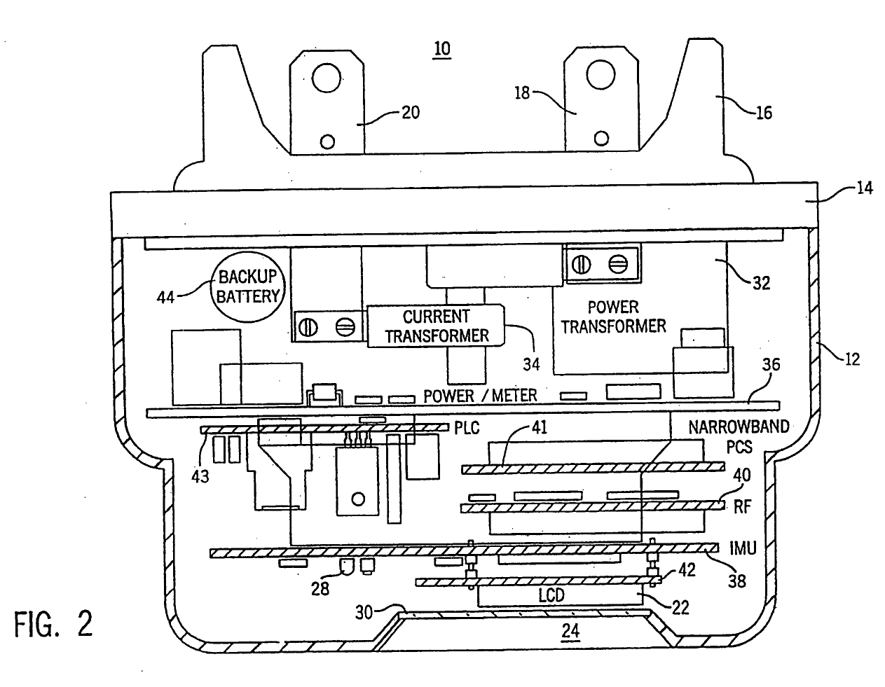

FIGS. 1 and 2 show a fully integrated, self-contained electronic electric meter 10 for measuring electricity usage and monitoring power quality. The meter 10 is operable for both single phase and three phase electric power installations. The meter 10 includes a top cover 12 attached to a meter base 14. Extending outwardly from the meter base 14 is a mounting frame 16 and a pair of terminals 18, 20. The meter 10 easily retrofits into existing meter sockets by insertion of terminals 18, 20 into the sockets and interlocking the mounting frame to secure the meter in place. The terminals 18, 20 complete the connection between the electric power line and the meter 10. The meter 10 further includes a liquid crystal display 22 for displaying meter readings and settings, units of measure and status conditions. The top cover 12 includes a rectangular opening 24 for the LCD 22. A rectangularly shaped transparent piece of glass or plastic covers the rectangular opening 24 for viewing LCD 22.

As shown in FIG. 2, the fully electronic, self-contained, modular electric meter 10 includes several electronic sub-assemblies. The sub-assemblies include a power transformer 32, a current transformer 34, a power/meter circuit board 36, an interface management unit circuit board 38, a RF transceiver sub-assembly 40, an LCD sub-assembly 42, and a variety of commercially available plug in network modules, such as a narrowband personal communication services (PCS) module 41 and a power line carrier (PLC) module 43. One class of PLC module 43 has a built-in interface for the CEBus architecture that transmit commands and data suitable for devices in households and offices. Electric meters with PLC modules having a CEBus interface can communicate with consumer devices or with networks using CEBus. If one or more CEBus devices is in the premises served by the electric meter, the meter can communicate with these devices on an in-premises network directly, or on behalf of other nodes by relaying messages between the in-premises device and other nodes.

All of the circuit boards and modules plug into a common backplane or busing system (not shown) providing a modular construction allowing for interchangeability of circuit boards and modules depending on the data communication network desired. While the meter 10 is shown as an electric meter, the meter 10 can also be configured to measure other physical characteristics such as water and gas.

### Circuitry of Electronic Electric Meter

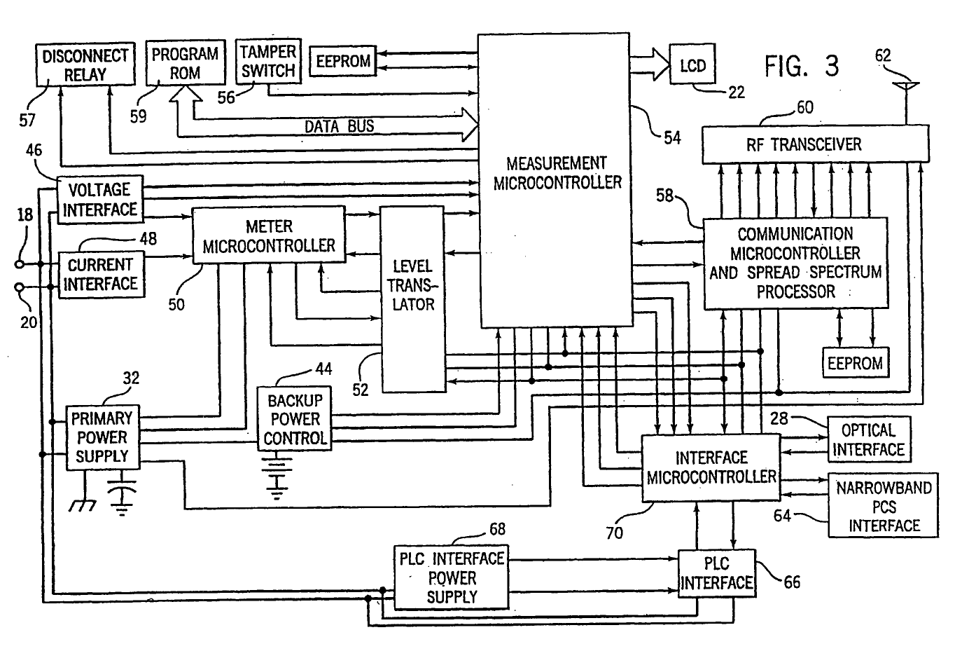

FIG. 3 shows a block diagram of the electric meter's internal circuitry. The meter 10 is powered directly from the electric power from the main lines connected to terminals 18, 20 and power transformer 32 to provide the DC power required of the meter circuitry. Back-up battery power 44 is provided in case of electrical power outages.

The electrical power flowing through terminals 18 and 20 is sensed by voltage interface transducer 46 and current interface transducer 48. Accumulated values from transducers 46 and 48 are input to meter microcontroller 50 which interprets the electrical signal data received from transducers 46 and 48. The processed electrical signal data is then sent through a level translator 52 to condition the signals for the required input into measurement microcontroller 54. Measurement microcontroller 54 performs additional calculations on the electrical signals received from meter microcontroller 50 and prepares them for output to the LCD 22 or an appropriate communication network. Meter microcontroller 50 may comprise the integrated circuit sold by SAMES of South Africa under the designation SA9603B. The measurement microcontroller 54 can be an SMOS chip available under the designation SMC AA316F03.

The measurement microcontroller 54 also monitors inputs from tamper switch 56 and disconnect relay 57 for disconnecting the meter from the electrical line. The program ROM 59 contains customer specific and site specific variables that may be important for calculating electricity usage. The meter 10 has an accuracy of approximately 0.2% for a power input current range of 0-200 amps. Other features that the measurement microcontroller 54 is able to measure are kilowatt hour usage, voltage and frequency measurements, energy direction, time and date reporting, load profiling and failure reporting. The power/meter circuit board includes measurement microcontroller 54, level translator 52, meter microcontroller 50, backup battery 44, and primary power supply 32.

Electric meter 10 is able to communicate commodity utilization data and power quality information to a utility over a local area network (LAN) or a wide area network (WAN). A radio frequency (RF) communication section within the electric meter 10 is comprised by a communication microcontroller and a spread spectrum processor chip 58 and an RF transceiver 60. An antenna 62 is coupled to the RF transceiver 60 for transmitting and receiving RF spread spectrum signals.

The communication microcontroller portion of chip 58 is responsible for all aspects of radio frequency (RF) communication management in electric meter 10 including determining the presence of a valid interrogating signal from a remotely located gateway node. The communication microcontroller portion of chip 58 provides control information to spread spectrum processor portion of chip 58 and RF transceiver 60 to control spread spectrum protocol and RF channelization. Communication microcontroller and spread spectrum processor chip 58 may comprise the integrated circuit sold by Siliconians of California, under the designation SS105.

The spread spectrum communication technique makes use of a sequential noise-like signal structure, for example, pseudo-noise (PN) codes to spread a normally narrowband information signal over a relatively wide band of frequencies. This spread spectrum communication technique may be further understood by reference to U.S. Pat. No. 5,166,952 and the numerous publications cited therein.

The use of the spread spectrum communication technique, when used in conjunction with the direct sequence modulation technique, hereinafter described, gives the LAN data communication system a measure of security. This communication technique also avoids the need to obtain licensure from governmental authorities controlling radio communication.

The spread spectrum processor portion of chip 58 functions to perform spread spectrum encoding of the data from communication microcontroller provided to RF transceiver 60 and decoding of the spread spectrum data from the RF transceiver. A better understanding of the spread spectrum communication technique can be obtained by reading the subject matter under the subheading entitled “Circuitry of Gateway Node”. The RF transceiver 60 and communication microcontroller and spread spectrum processor chip 58 are part of the circuitry on interface management unit board 38 and RF module 40 of FIG. 2.

The meter 10 also includes plugin interface modules which correspond to a variety of different commercially available LAN or WAN communication devices. These communication devices provide a communication link directly from the electric meter 10 to a utility service provider. For example, shown in FIG. 3, is a narrow band personal communication services (PCS) interface module 64, and a power line carrier (PLC) interface module 66 powered by a PLC interface power supply 68. These communication interface modules are easily interchangeable within electric meter 10.

Some classes of PLC modules can have a built-in interface for the CEBus architecture. This interface enables the meter to communicate over the PLC interface with external consumer networks via the PLC CEBus interface. In addition to power lines, the CEBus interface can be employed with twisted pair cable, coaxial cable, RF communications and infrared communications. In one embodiment, the CEBus architecture includes spread spectrum modulation on the power line. Spread spectrum involves starting a modulation at one frequency, and altering the frequency during its cycle. The CEBus power line interface begins each burst at 100 kHz, and increases linearly to 400 kHz during a 100 microsecond duration. Both the bursts (referred to as “superior” state) and the absence of burst (referred to as the “inferior” state) create similar digits, so a pause in between states is not necessary.

A logical one digit is created by an inferior or superior state that lasts 100 microseconds, and a logical zero digit is created by an inferior or superior state that lasts 200 microseconds. Consequently, the transmission rate is variable, depending upon how many of the characters are ones and how many are zeros; the average rate is about 7,500 bits per second. A 400 microsecond burst is an end of frame indicator and also saves time. For example, if a 32-bit destination address field has some of its most significant bits zero, they need not be sent; the end of frame delimits the field and all receiving devices assume the untransmitted bits are zero.

CEBus transmissions are strings or packets of data that also vary in length, depending upon how much data is included. Some packets can be hundreds of bits in length. The minimum packet size is 64 bits, which at an average rate of 7,500 bits per second, will take about 1/117th of a second to be transmitted and received.

Other modulation schemes and formats may be used in the CEBus interface to communicate with the connected external networks using CEBus architecture and protocols. Additionally or alternatively, protocols or standards other than CEBus may be used to communicate with other devices on the network or networks, including devices on network(s) within the premises to which the metered commodity is delivered. Such protocols or standards may be implemented on a PLC module, a PCS module, or other communication module of the electric meter. When the protocol employed in the in-premises network is different from that used to communicate with the utility, e.g. via the LAN 74, the communication microcontroller 58 reformats messages received by at RF transceiver for transmission via the in-premises network to a device associated with the premises, and vice versa, according to the respective protocols of each network.

These modules communicate with the measurement microcontroller 54 and an interface microcontroller 70 along a common backplane or busing system (not shown). Exemplary meter interfaces include the PowerPoint electronic meter interface for the GE KVII meter equipped with an internal antenna, or the GE KVII meter equipped with an external antenna. When the meter 10 is configured to measure water or aqueous characteristics, a water interface management unit (“IMU”) interface such as the Silver Spring Network water IMU can be used. When the meter 10 is configured to measure gaseous characteristics, the Silver Spring Network gas IMU is an exemplary interface. Other exemplary interfaces include MTC Raven communications package V2.2, Siemens S4 communication package V2.2, or Schlumberger Vectron communication package V2.2.

### Networked Automatic Meter Reading Data Communication System

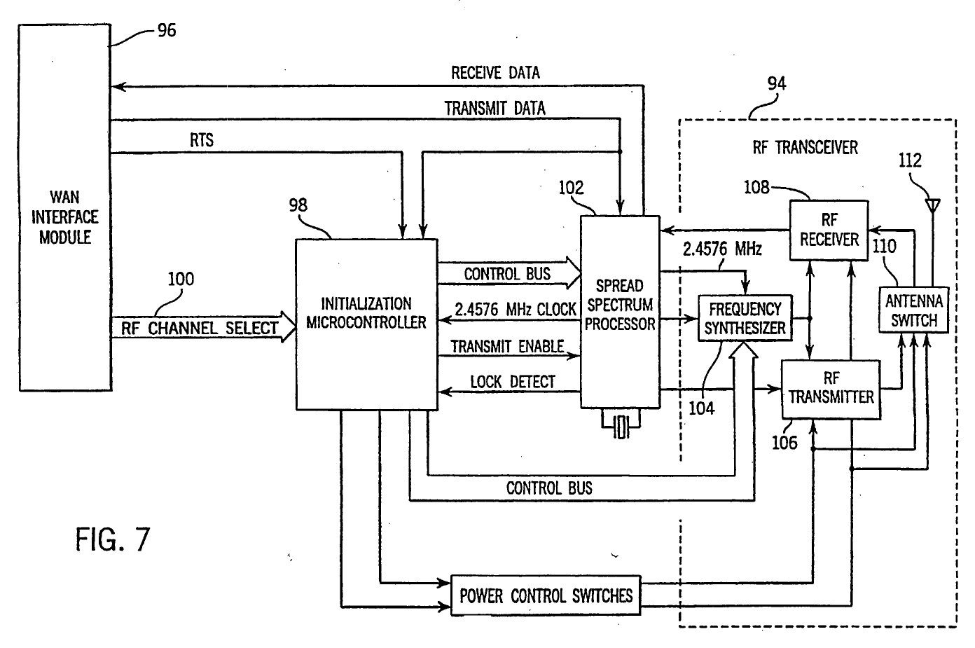

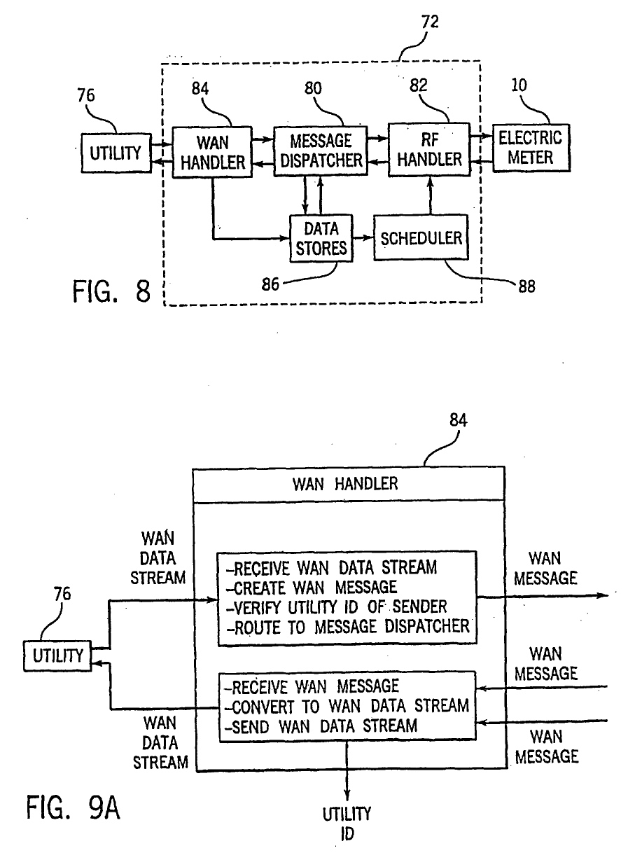

In one embodiment of the invention, illustrated in FIGS. 5 and 6, the electric meter 10 communicates over a local area network (LAN) 74 to a gateway node 72 which transmits the commodity data from the electric meter 10 to a utility 76 over a fixed common carrier wide area network (WAN) 78. The gateway node 72 provides the end to end communication links from the meter 10 to the utility 76. A first link in the data communication system can be a two-way 900 MHz spread spectrum LAN 74. The second link within the data communication system is designed to be any commercially available two-way common carrier WAN 78. In this embodiment, a gateway node 72 must be within the communication range of the electric meter 10 which is approximately one mile.

In an alternate embodiment, the electric meter 10 provides direct local area and wide area network access through printed circuit board sub-assemblies installed in meter 10 described above.

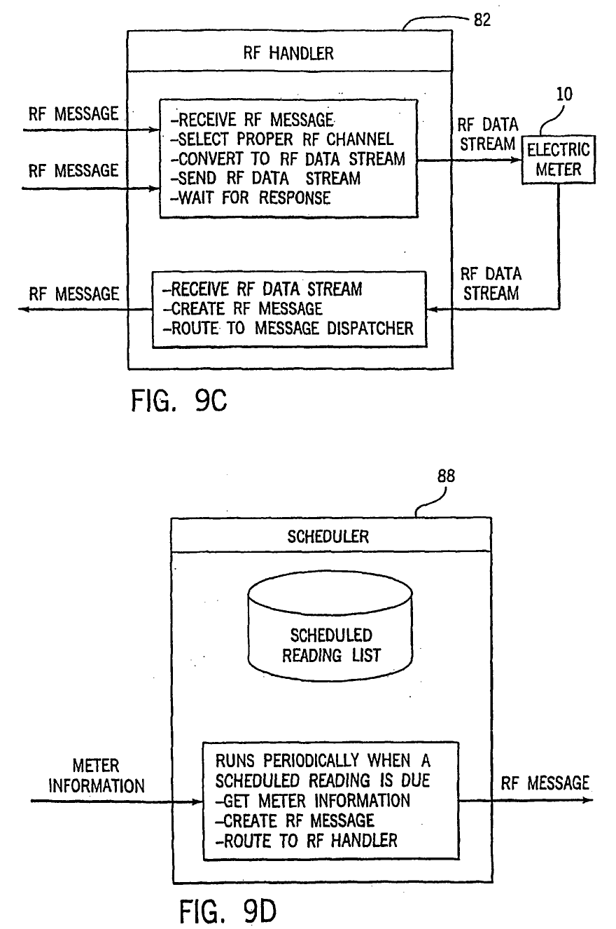

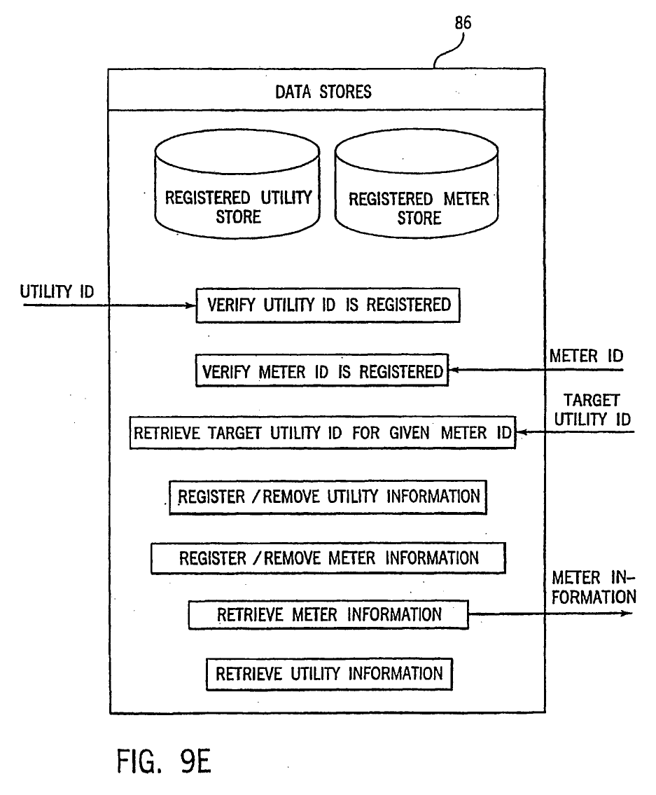

A more detailed representation of the preferred embodiment is shown in FIGS. 8 and 9A-9E. FIG. 8 shows a functional flow diagram of the networked automatic meter reading data communication system of the present invention in which the components are described as functional blocks. The flow diagram of FIG. 8, includes the main functional components of the gateway note 72 which include a message dispatcher 80, an RF handler 82, a WAN handler 84, a data stores component 86 and a scheduler component 88. The data stores and scheduler components comprise data that is preprogrammed into the gateway node's memory. The gateway node 72 interfaces with the electric meter 10 over the two-way wireless LAN 74. The gateway node 72 also interfaces with the utility service provider 76 over the fixed common carrier WAN 78.

FIG. 9A is a detailed functional diagram of the WAN handler 84 of FIG. 8. In a typical communication episode, the utility 76 may initiate a request for data from the electric meter 10 by sending a data stream over the WAN 78. The WAN handler 84 of the gateway node 72 receives the WAN data stream, creates a WAN message, verifies the utility ID of the sender from the data stores 86 and routes the WAN message to the message dispatcher 80 in the gateway node.

Referring now to FIG. 9B, the message dispatcher 80 receives the WAN message from the WAN handler 84 and determines the request from the utility 76. The message dispatcher 80 determines that the end recipient or target is the electronic meter 10. The message dispatcher 80 then verifies the meter ID from the data stores 86, creates an RF message and routes the RF message to the RF handler 82.

Referring now to FIG. 9C, the RF handler 82 receives the RF message from the message dispatcher 80, selects a proper RF channel, converts the RF message to an RF data stream, sends the RF data stream to the electric meter 10 over the LAN 74 and waits for a response. The electric meter 10 then responds by sending an RF data stream over the LAN 74 to the RF handler 82 of the gateway node 72. The RF handler 82 receives the RF data stream, creates an RF message from the RF data stream and routes the RF message to the message dispatcher 80. As shown in FIG. 9B, the message dispatcher 80 receives the RF message, determines the target utility for response from the data stores 86, creates a WAN message and routes the WAN message to the WAN handler 84. The WAN handler 84 receives the WAN message from the message dispatcher 80, converts the WAN message to a WAN data stream and sends the WAN data stream to the utility 76 over the fixed common carrier WAN 78, as shown in FIG. 9A to complete the communication episode.

A communication episode can also be initiated by scheduled readings preprogrammed into the scheduler 88 of the gateway node as shown in FIG. 9D. A list of scheduled reading times is preprogrammed into memory within the gateway node 72. The scheduler 88 runs periodically when a scheduled reading is due. When it is time for a scheduled reading, the scheduler 88 retrieves meter 10 information from the data stores 86, creates an RF message and routes the RF message to the RF handler 82, receives the RF message, selects a proper RF channel, converts the RF message to an RF data stream, sends the RF data stream to the electric meter 10 and waits for a response. The meter then responds with an RF data stream to the RF handler 82. The RF handler 82 receives the RF data stream, creates an RF message from the RF data stream and routes the RF message to the message dispatcher 82. The message dispatcher 80 receives the RF message, determines the target utility for response from the data stores 86, creates a WAN message and routes the WAN message to the WAN handler 84. The WAN handler 84 receives the WAN message, converts the WAN message to a WAN data stream and sends the WAN data stream to the utility 76.

Occasionally, the utility 76 may request data that is stored within the gateway node's memory. In this case, the utility 76 initiates the communication episode by sending a WAN data stream to the WAN handler 84. The WAN handler 84 receives the WAN data stream, creates a WAN message, verifies the utility ID of the sender in the data stores 86 and routes the WAN message to the message dispatcher 80. As shown in FIG. 9B, the message dispatcher 80 receives the WAN message and determines the request from the utility 76. The message dispatcher 80 then determines the target of the message. If the data requested is stored in the gateway node memory, then the gateway node 72 performs the requested task, determines that the requesting utility is the target utility for a response, creates a WAN message and routes the WAN message to the WAN handler 84. The WAN handler 84 receives the WAN message, converts the WAN message to a WAN data stream and sends the WAN data stream to the utility 76.

The last type of communication episode is one which is initiated by the electric meter 10. In this case, the meter detects an alarm outage or tamper condition and sends an RF data stream to the RF handler 82 of the gateway node 72. The RF handler 82 receives the RF data stream, creates an RF message from the RF data stream and routes the RF message to the message dispatcher 80. The message dispatcher 80 receives the RF message, determines the target utility for response from the data stores 86, creates a WAN message and routes the WAN message to the WAN handler 84. The WAN handler 84 receives the WAN message, converts the WAN message to a WAN data stream and sends the WAN data stream to the utility 76.

There are thus three different types of communication episodes that can be accomplished within the automatic meter reading data communication system shown in FIGS. 8 and 9A-E. These three episodes are respectively initiated by the utility, the gateway mode, or the meter. The automatic meter reading functions incorporated in electric meter 10 include monthly usage readings, demand usage readings, outage detection and reporting, tamper detection and notification, load profiling, first and final meter readings, and virtual shutoff capability.

FIG. 9D represents information or data that is preprogrammed into the gateway node's memory. Included within the memory is a list of scheduled reading times to be performed by the interface management unit. These reading times may correspond to monthly or weekly usage readings, etc.

FIG. 9E represents data or information stored in the gateway node's memory dealing with registered utility information and registered interface management unit information. This data includes the utility identification numbers of registered utilities, interface management unit identification numbers of registered interface management units, and other information for specific utilities and specific interface management units, so that the gateway node can communicate directly with the desired utility or correct electric meter.

### Electronic Electric Meter Virtual Shut-Off Function

The virtual shut-off function of the electric meter 10 is used for situations such as a change of ownership where a utility service is to be temporarily inactive. When a residence is vacated there should not be any significant consumption of electricity at that location. If there is any meter movement, indicating unauthorized usage, the utility needs to be notified. The tamper switch 56 of the electric meter 10 provides a means of flagging and reporting meter movement beyond a preset threshold value.

Activation of the virtual shut-off mode is accomplished through a “set virtual threshold” message, defined as a meter count which the electric meter is not to exceed. In order to know where to set the threshold it is necessary to know the present meter count. The gateway node reads the meter count, adds whatever offset is deemed appropriate, and sends the result to the electric meter as a “set virtual shut-off” message. The electric meter then enables the virtual shut-off function. The electric meter then accumulates the meter counts. If the meter count is greater than the preset threshold value then the electric meter sends a “send alarm” message to the gateway node until a “clear error code” message is issued in response by the gateway node. However, if the meter count is less than the preset threshold value then the electric meter continues to monitor the meter count. The virtual shut-off function may be canceled at any time by a “clear error code” message from the gateway node.

If the meter count in the meter does not exceed the preset threshold value at any given sampling time, then the meter continues to count until the preset threshold count is attained or until operation in the virtual shut-off mode is canceled.

### Gateway Node

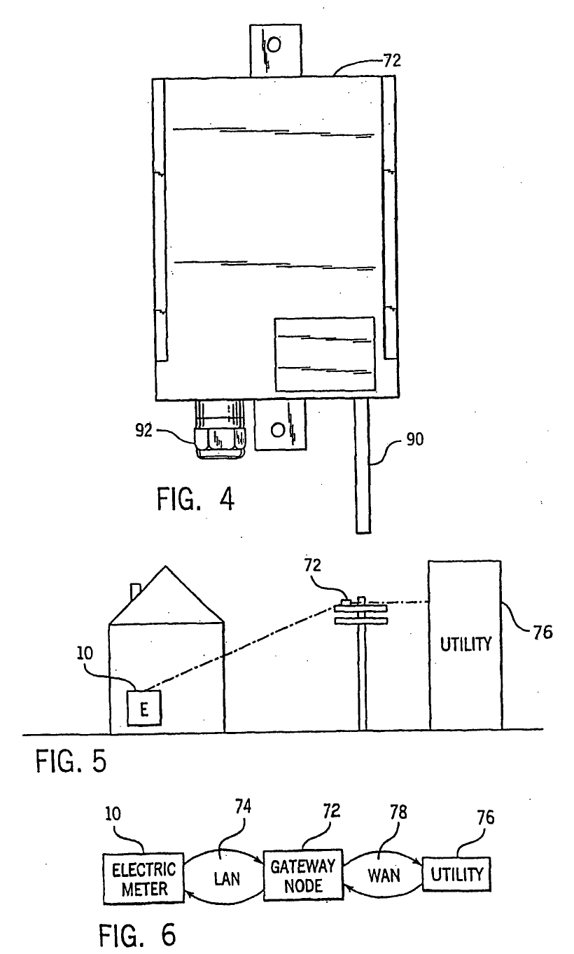

The gateway node 72 is shown in FIG. 4. The gateway node 72 is typically located on top of a power pole or other elevated location so that it can act as a communication node between LAN 74 and WAN 78. The gateway node 72 includes an antenna 90 for receiving and transmitting data over the RF communication links, and a power line carrier connector 92 for connecting a power line to power the gateway node 72. The gateway node 72 can also be solar powered. The compact design allows for easy placement on any existing utility pole or similarly situated elevated location. The gateway node 72 provides end to end communications from the meter 10 to the utility 76. The wireless gateway node 72 interfaces with the electric meter 10 over a two-way wireless 900 MHz spread spectrum LAN 74. Also, the gateway node 72 interfaces and is compatible with any commercially available WAN 78 for communicating commodity usage and power quality information with the utility. The gateway node 72 is field programmable to meet a variety of data reporting needs.

The gateway node 72 receives data requests from the utility, interrogates the meter and forwards commodity usage information, as well as power quality information, over the WAN 78 to the utility 76. The gateway node 72 exchanges data with certain, predetermined, meters for which it is responsible, and “listens” for signals from those meters. The gateway node 72 does not store data for extended periods, thus minimizing security risks. The gateway node's RF communication range is typically one mile.

A wide variety of fixed wide area network (WAN) communication systems such as those employed with two-way pagers, cellular telephones, conventional telephones, narrowband personal communication services (PCS); cellular digital packet data (CDPD) systems, and satellites may be used to communicate data between the gateway nodes and the utility. The data communication system utilizes channelized direct sequence 900 MHz spread spectrum transmissions for communicating between the meters and gateway nodes. An exemplary gateway node includes the Silver Spring Network Gateway node that uses the AxisPortal V2.2 and common carrier wide area networks such as telephone, code-division multiple access (“CDMA”) cellular networks. Another exemplary gateway node includes the Silver Spring Network AxisGate Network Gateway.

### Circuitry of Gateway Node

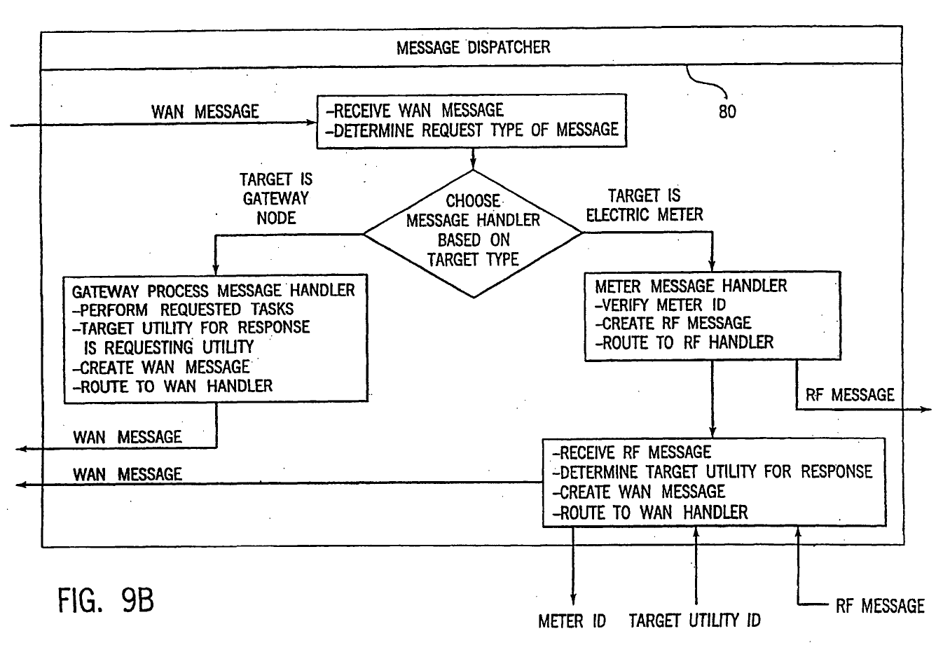

FIG. 7 shows a block diagram of the gateway node circuitry. The RF transceiver section 94 of gateway node 72 is the same as the RF transceiver section 60 of electric meter 10 and certain portions thereof, such as the spread spectrum processor and frequency synthesizer, are shown in greater detail in FIG. 7. The gateway node 72 includes a WAN interface module 96 which may incorporate electronic circuitry for a two-way pager, power line carrier (PLC), satellite, cellular telephone, fiber optics, cellular digital packet data (CDPD) system, personal communication services (PCS), or other commercially available fixed wide area network (WAN) system. One class of PLC modules may include the CEBus interface to enable the gateway to communicate with external consumer networks utilizing CEBus protocols and architecture. The gateway can forward messages to/from the external CEBus nodes to servers located in the WAN. The construction of WAN interface module 96 and initialization microcontroller 98 may change depending on the desired WAN interface. RF channel selection is accomplished through an RF channel select bus 100 which interfaces directly with the initialization microcontroller 98.

Initialization microcontroller 98 controls all node functions including programming spread spectrum processor 102, RF channel selection in frequency synthesizer 104 of RF transceiver 94, transmit/receive switching, and detecting failures in WAN interface module 96.

Upon power up, initialization microcontroller 98 programs the internal registers of spread spectrum processor 102, reads the RF channel selection from the electric meter 10, and sets the system for communication at the frequency corresponding to the channel selected by the meter 10.

Selection of the RF channel used for transmission and reception is accomplished via the RF channel select bus 100 to initialization microcontroller 98. Valid channel numbers range from 0 to 23. In order to minimize a possibility of noise on the input to initialization microcontroller 98 causing false channel switching, the inputs are debounced through software. Channel selection data must be present and stable on the inputs to initialization microcontroller 98 for approximately 250 μs before the initialization microcontroller will accept it and initiate a channel change. After the channel change has been initiated, it takes about 600 μs for frequency synthesizer 104 of RF transceiver 94 to receive the programming data and for the oscillators in the frequency synthesizer to settle to the changed frequency. Channel selection is only completed while gateway node 72 is in the receive mode. If the RF channel select lines are changed during the transmit mode the change will not take effect until after the gateway node has been returned to the receive mode.

Once initial parameters are established, initialization microcontroller 98 begins its monitoring functions. When gateway node 72 is in the receive mode, the initialization microcontroller 98 continuously monitors RF channel select bus 100 to determine if a channel change is to be implemented.

For receiving data, gateway node 72 monitors the electric meter 10 to determine the presence of data. Some additional handshaking hardware may be required to sense the presence of a spread spectrum signal.

An alarm message is sent automatically by electric meter 10 in the event of a tamper or alarm condition, such as a power outage. The message is sent periodically until the error has cleared. Gateway node 72 must know how many bytes of data it is expecting to see and count them as they come in. When the proper number of bytes is received, reception is deemed complete and the message is processed. Any deviation from the anticipated number of received bytes may be assumed to be an erroneous message.

During the transmit mode of gateway node 72, initialization microcontroller 98 monitors the data line to detect idle conditions, start bits, and stop bits. This is done to prevent gateway node 24 from continuously transmitting meaningless information in the event a failure of WAN interface module 96 occurs and also to prevent erroneous trailing edge data from being sent which cannot terminate transmissions in a timely fashion. The initialization microcontroller 98 will not enable RF transmitter 106 of RF transceiver 94 unless the data line is in the invalid idle state when communication is initiated.

A second watchdog function of initialization micro-controller 98 when gateway node 72 is in the transmit mode is to test for valid start and stop bits in the serial data stream being transmitted. This ensures that data is read correctly. The first start bit is defined as the first falling edge of serial data after it has entered the idle stage. All further timing during that communication episode is referenced from that start bit. Timing for the location of a stop bit is measured from the leading edge of a start bit for that particular byte of data. Initialization microcontroller 98 measures an interval which is 9.5 bit times from that start bit edge and then looks for a stop bit. Similarly, a timer of 1 bit interval is started from the 9.5 bit point to look for the next start bit. If the following start bit does not assert itself within 1 bit time of a 9.5 bit time marker a failure is declared. The response to a failure condition is to disable RF transmitter 106.

Communication to and from electric meter 10 may be carried out in one of a preselected number of channels, for example 24, in a preselected frequency band, for example 902-928 MHz. The meter 10 receives data and transmits a response on a single RF channel which is the same for both transmit and receive operations. As hereinafter described, the specific RF channel used for communication is chosen during commissioning and installation of the unit and loaded into memory. The RF channel is chosen to be different from the operating channels of other, adjacent interface management units, thereby to prevent two or more interface management units from responding to the same interrogation signal.

Frequency synthesizer 104 performs the modulation and demodulation of the spread spectrum data provided by spread spectrum processor 102 onto a carrier signal and demodulation of such data from the carrier signal. The RF transceiver has separate transmitter 106 and receiver 108 sections fed from frequency synthesizer 104.

The output of the spread spectrum processor to frequency synthesizer comprises a 2.4576 MHz reference frequency signal in conductor and a PN encoded base band signal in conductor. The frequency synthesizer may comprise a National Semiconductor LMX2332A Dual Frequency Synthesizer.

The direct sequence modulation technique employed by the frequency synthesizer uses a high rate binary code (PN code) to modulate the base band signal. The resulting spread signal is used to modulate the transmitter's RF carrier signal. The spreading code is a fixed length PN sequence of bits, called chips, which is constantly being recycled. The pseudo-random nature of the sequence achieves the desired signal spreading, and the fixed sequence allows the code to be replicated in the receiver for recovery of the signal. Therefore, in direct sequence, the base band signal is modulated with the PN code spreading function, and the carrier is modulated to produce the wide band signal.

Minimum shift keying (MSK) modulation is used in order to allow reliable communications, efficient use of the radio spectrum, and to keep the component count and power consumption low. The modulation performed by frequency synthesizer 72 is minimum shift keying (MSK) at a chip rate of 819.2 Kchips per second, yielding a transmission with a 6 dB instantaneous bandwidth of 670.5 KHz.

The receiver bandwidth of this spread spectrum communication technique is nominally 1 MHz, with a minimum bandwidth of 900 KHz. Frequency resolution of the frequency synthesizer is 0.2048 MHz, which is used to channelize the band into 24 channels spaced a minimum of 1.024 MHz apart. This frequency channelization is used to minimize interference between interface management units within a common communication range as well as providing growth for future, advanced features associated with the data communication system.

Frequency control of the RF related oscillators in the system is provided by dual phase locked loop (PLL) circuitry within frequency synthesizer. The phase locked loops are controlled and programmed by initialization microcontroller via a serial programming control bus, FIG. 7. The frequency synthesizer produces two RF signals which are mixed together in various combinations to produce a transmission carrier and to demodulate incoming RF signals. The transmission carrier is based on frequencies in the 782-807 MHz range and the demodulation signal is based on frequencies in the 792-817 MHz range. These signals may be referred to as RF transmit and RF receive local oscillation signals.

Table 1 below is a summary of the transmission channel frequencies and associated frequency synthesizer transmit/receive outputs. The signals in the table are provided by the two PLL sections in the dual frequency synthesizer.

TABLE 1

| Channel | Channel | Transmit Local | Receive Local |
|---|---|---|---|
| Number | Frequency (MHz) | Oscillation (MHz) | Oscillation (MHz) |
| 0 | 902.7584 | 782.3360 | 792.1664 |
| 1 | 903.7824 | 783.3600 | 793.1904 |
| 2 | 904.8064 | 784.3840 | 794.2144 |
| 3 | 905.8304 | 785.4080 | 795.2384 |
| 4 | 906.8544 | 786.4320 | 796.2624 |
| 5 | 907.8784 | 787.4560 | 797.2864 |
| 6 | 908.9024 | 788.4800 | 798.3104 |
| 7 | 910.1312 | 789.7088 | 799.5392 |
| 8 | 911.1552 | 790.7328 | 800.5632 |
| 9 | 912.1792 | 791.7568 | 801.5872 |
| 10 | 913.2032 | 792.7808 | 802.6112 |
| 11 | 914.2272 | 793.8048 | 803.6352 |
| 12 | 915.2512 | 794.8288 | 804.6592 |
| 13 | 916.2752 | 795.8528 | 805.6832 |
| 14 | 917.2992 | 796.8768 | 806.7072 |
| 15 | 918.3232 | 797.9008 | 807.7312 |
| 16 | 919.9616 | 799.5392 | 809.3696 |
| 17 | 920.9856 | 800.5632 | 810.3936 |
| 18 | 922.0096 | 801.5872 | 811.4176 |
| 19 | 923.2384 | 802.8160 | 812.6464 |
| 20 | 924.2624 | 803.8400 | 813.6704 |
| 21 | 925.2864 | 804.8640 | 814.6944 |
| 22 | 926.3104 | 805.8880 | 815.7184 |
| 23 | 927.3344 | 806.9120 | 816.7424 |

A third signal, which is fixed at 120.4224 MHz, is also supplied by the dual frequency synthesizer. This signal is referred to as the intermediate frequency (IF) local oscillation signal.

In transmission mode, frequency synthesizer 104 provides a signal having a frequency in the 782-807 MHz range, modulated with the data to be transmitted. RF transmitter section 106 mixes the signal with the fixed frequency IF local oscillator signal. This results in a RF signal which ranges between 902 MHz and 928 MHz. The signal is filtered to reduce harmonics and out of band signals, amplified and supplied to antenna switch 110 and antenna 112.

It will be recognized that other equivalents, alternatives, and modifications aside from those expressly stated, are possible and within the scope of the appended claims.

What is claimed is:

1. A communications node associated with a commodity meter that produces data relating to characteristics of a commodity that is provided to a premises, comprising:
a first communication interface that is operable to exchange data between said meter and a provider-accessible first wireless network;
a second communication interface that is operable to exchange data between said node and a second network that is external to said node; and
an interface controller operably connected to said first and second communication interfaces for exchanging data between said interfaces, to thereby enable data to be transmitted to and/or received from said second network via said first, wireless network.

2. The communications node of claim 1, wherein said second communication interface comprises one of a power line carrier interface and a personal communications service interface.

3. The communications node of claim 1, wherein the second communications interface is a removable module.

4. The communications node of claim 1, wherein the second communications node provides a CEBus interface.

5. The communications node of claim 4, wherein the CEBus interface provides communication to at least one device in said premises via a power line carrier.

6. The communications node of claim 4, wherein the CEBus interface provides communication to at least one in said premises via a wireless radio.

7. The communications node of claim 1, wherein the second communication interface provides communication to at least one in said premises via a wireless radio.

8. The communications node of claim 7, wherein the first wireless network communicates via IP protocols.

9. A communications node, comprising:
a first communications interface that is operable to exchange data between the communications node and a first wireless network;
a second communications interface that is operable to exchange data between the communications node and a commodity meter;
a third communications interface that is operable to exchange data between the communications node and devices within a premises associated with said commodity meter;
a processor for exchanging data between the first communications interface, the second communication interface, and the third communications interface.

10. The communications node of claim 9, wherein the third communications interface provides a CEBus interface.

11. The communications node of claim 10, wherein the CEBus interface provides communication to at least one in-premise device via a power line carrier.

12. The communications node of claim 9, wherein the third communications interface operates according to a protocol that is different from the protocol of the first transmission interface, and wherein the processor reformats messages received by the first communications interface for transmission via the third communication interface to a device associated with the premises.

13. The communications node of claim 12, wherein the first wireless network uses IP protocols.

14. A communications node associated with a commodity meter that produces data relating to characteristics of a commodity that is provided to a premises, comprising:
a first communication interface that is operable to exchange data between said meter and a provider of said commodity, via a wireless network;
a second communication interface that is operable to exchange data between said node and an in-premise network connected to one or more devices within said premises; and
an interface controller operably connected to said first and second communication interfaces for exchanging data between said interfaces, to thereby enable data to be transmitted to and/or received from devices within said premises via said wireless network.

15. The communications node of claim 14, wherein said second communication interface comprises a power line carrier interface.

16. The communications node of claim 14, wherein said second communication interface includes a CEBus interface.

17. The communication node of claim 14, wherein said second communication interface exchanges data with said devices by means of spread spectrum modulation.

18. The communication node of claim 14, wherein said wireless network is a local area network via which said first interface communicates with a gateway node that is also a component of a second a network affiliated with said commodity provider.

19. The communication node of claim 14, wherein said wireless network is a wide area network affiliated with said commodity provider.

20. The communication node of claim 14, further including a third interface via which said node communicates with said meter to obtain said data relating to characteristics of the commodity.

21. A method of operating a network node associated with a commodity meter that produces data relating to characteristics of a commodity that is provided to a premises, comprising:
obtaining data produced by said meter that relates to characteristics of the commodity;
providing said obtained data from the node to a provider of the commodity via a first network;
communicating with the devices located in the premises associated with the commodity meter, via a second network; and
exchanging data between said first and second networks in said node, to thereby enable communications to be conducted with devices located in the premises via said first network.

22. The method of claim 21, wherein data is transmitted via said second network with a protocol that is different from a protocol that is used to transmit data via said first network, and wherein said exchanging step includes the step of reformatting data that is exchanged between said first and second networks in said node, in accordance with the respective protocols.

23. The method of claim 22, wherein said first network uses IP protocols to transmit data.

24. The method of claim 22, wherein said second network uses CEBus protocols to transmit data.

25. The method of claim 21, wherein each of said first and second networks are wireless networks.
